(19) United States
(12) Patent Application Publication
(10) Pub. No.: US 2011/0146000 A1
(43) Pub. Date: Jun. 23, 2011

(54) METHOD OF REDUCING THE OCCURRENCE OF SPONTANEOUS COMBUSTION OF OIL-SOAKED ARTICLES

(75) Inventors: Gregory G. Griese, Hudson, WI (US); Richard J. Walsh, Woodbury, MN (US)

(73) Assignee: ECOLAB USA INC., ST. PAUL, MN (US)

(21) Appl. No.: 12/967,586

(22) Filed: Dec. 14, 2010

Related U.S. Application Data
(60) Provisional application No. 61/289,157, filed on Dec. 22, 2009.

(51) Int. Cl. D06L 1/16; C11D 3/386; D06M 16/00

(52) U.S. Cl. 8/137; 510/530; 510/320; 435/263

(57) ABSTRACT

A method of reducing the occurrence of spontaneous combustion of oil-stained articles is disclosed. The method comprises the steps of providing an article previously contacted with oil, the oil comprising at least one cis-configured double bond in the fatty acid, providing a solution comprising lipoxygenase, applying the solution to the article for sufficient time to treat the oil wherein treating comprises allowing the lipoxygenase to alter the cis-configured double bonds in the oil.

### RELATED CASES

This application claims priority under 35 U.S.C. §119(e) to U.S. Provisional Application entitled “Method of Reducing the Occurrence of Spontaneous Combustion of Oil-Soaked Articles”, Ser. No. 61/289,157, filed on Dec. 22, 2009, which is incorporated herein by reference in its entirety for all purposes.

### FIELD OF THE INVENTION

The present invention relates to the reduction of spontaneous combustion of oil-soaked articles. In particular, the invention is directed toward reducing combustion of articles used to clean oily surfaces, or those articles cleaned by using oils.

### BACKGROUND OF THE INVENTION

Commercial laundry facilities collect linens from multiple customers at various sites, transport these linens to a single facility where the linens are washed, dried, sometimes pressed and folded. The launderer then transports the linens back to the various customers' sites to deliver the freshly laundered linens. Certain linens may spontaneously combust due to the soil coated on them and the holding conditions of the soiled linens. If holding conditions are not properly vented, heat is unable to escape, causing the temperature of the stored articles to rise. Once the temperature of the material rises above its ignition point combustion ensues if sufficient oxygen is present. This phenomenon is a problem in a number of industries, including restaurants, contractors, and painters. In particular, restaurant workers may use linens to clean oil-containing soils or spills. Commercial launderers who service customers such as restaurants are in danger of spontaneous combustion of these oil-stained linens.

Vegetable oils are polyunsaturated fatty acids meaning that more than one double bond exists within the molecule. Polyunsaturated fatty acids can assume a cis or trans conformation depending on the geometry of the double bond. Cis-configured fatty acids are otherwise referred to as non-trans fatty acids. It is well known that polyunsaturated fatty acids are healthier to ingest than their saturated (or trans) fatty acid counterparts. Cis-configured fatty acids are less stable than their trans fatty acid counterparts. Examples of cis-configured fatty acids commonly found in vegetable and nut-based oils include but are not limited to linoleic and linolenic acids. Due to the cis-configuration of the bonds in these fatty acids, the molecules are highly unstable and highly reactive. Linoleic acid has 2 conjugated bonds and linolenic acid has 3 such bonds. Any molecule having greater than one cis-configured double bond is unstable. Linoleic and linolenic fatty acids are both extremely unstable molecules.

One example of an oil containing the dangerous fatty acids is soybean oil. The major unsaturated fatty acids in soybean oil triglycerides are 7% linolenic acid (C-18:3); 51% linoleic acid (C-18:2); and 23% oleic acid (C-18:1). Additionally, soybean oil contains the saturated fatty acids 4% stearic acid and 10% palmitic acid but these are not believed to pose the same threat as the linoleic and linolenic acids. Linoleic acid is a polyunsaturated fatty acid found in the lipids of cell membranes. It is abundant in many other vegetable oils, including fish oils, and especially in safflower and sunflower oils.

With the advent of and increased use of vegetable and nut-based oils, restaurateurs and commercial launderers alike have complained that oily linens, or those linens used to mop up or wipe cooking oil, may spontaneously combust resulting in dangerous fires during transportation of the linens or during a holding stage before laundering, during drying, or during transport back to the customer's facility. As can be appreciated, whenever such a fire occurs it is extremely dangerous, however, during transportation in a gas-powered vehicle such spontaneous combustion often proves deadly for the unsuspecting driver because the fire causes the fuel tank to combust and explodes. Bystanders may also be killed or at least injured.

Restaurant owners also complain of spontaneous combustion of such oil-stained linens. One easily recognizes the danger of a kitchen fire and the danger of such a fire growing quickly out of control. Direct gas or propane lines often feed kitchen appliances such as stoves, griddles, and ovens. Once these gas sources are ignited, the gas source must be closed before the fire may be successfully extinguished. Also, supplies of new and used oils such as those used for deep fat frying are stored in restaurant kitchens. These oil stores may also ignite thereby further fueling the fire. It was once believed that only oil-stained or soaked rags were fire hazards; however, it has recently come to our attention that even after an oil-stained linen has been laundered, a fire risk still remains. Therefore, the fire risk remains equally perilous for the restaurateur and the commercial launderer before and after laundering of the linens has occurred.

In the past it was believed that simply immersing such oil-stained linens in water until they were laundered provided a safe means for storing these rags. However, since the oil remains even after washing, this no longer provides a safe alternative to handling the linens. Immersing in water is certainly not an answer to the problem of the linens igniting throughout their lifetime since the commercial launderer remains at risk during transport from its customer's facilities, during the washing and drying phases, and during transport back to its customer's facilities. The risk surprisingly remains for the restaurateur when storing freshly laundered linens that are seemingly clean.

The risk of spontaneous combustion of oil-stained or soaked articles is equally dangerous for painters or any contractor using oils containing cis-fatty acids having more than one double bond. Painters use linseed oil as a carrier oil for their paints and also to clean their brushes. Oil-soaked rags are a spontaneous combustion hazard because as the oil oxidizes, heat is released. If the heat is not dissipated, it can build up and ignite the rags. Special oily-waste cans could be used to store oil-soaked rags. These containers need to allow air to flow around the rags, thus dissipating the heat. The waste cans should not have plastic liners and they should be emptied daily. However, as already discussed oil-waste containers fail to alleviate the problem of laundered articles that have enough residual cis-fatty acids on them to spontaneously combust and ignite the article.

A need exists for a method of reducing or eliminating spontaneous combustion of oil-stained articles.

### SUMMARY OF THE INVENTION

The invention provides a method of treating oil-stained articles such as linens to reduce the occurrence of combustion of the linens. The method includes providing an article previously contacted with oil, the oil having at least one component comprising at least two cis-configured double bonds, providing a solution comprising lipoxygenase, applying the solution to the article for sufficient time to treat the oil wherein treating comprises allowing the lipoxygenase to alter at least all but one of the cis-double bonds in the oil.

The invention provides treating the article before washing yet after contact with the oil. The invention also provides treating the article during laundering. The method of the invention is useful wherein the oil is comprised of at least one component having at least two cis-configured bonds in the fatty acid. An example of such a component includes but is not limited to linolenic acid or linoleic acid. The method of the invention is particularly effective at reducing the occurrence of spontaneous combustion when the oil is comprised of linolenic acid and the treating step alters at least one of the cis-double bonds present in the linolenic acid.

The method of the invention provides a method of degrading all of the cis-configured double bonds present in the polyunsaturated fatty acids. The method of the invention may be used on any article soiled with oils containing such a component. Such articles include but are not limited to linens, paintbrushes, and the like.

The present invention is useful in preparing and in use as a presoak or prewash, or a cleaning agent for treating a variety of surfaces.

### DETAILED DESCRIPTION OF INVENTION EMBODIMENTS

As used herein, the term “article” refers to any item that may become soaked or stained with cis-configured polyunsaturated fatty acids including but not limited to linens, walls, ceilings, floors, industrial frying vats, griddles, cook tops, grills, and paintbrushes.

When the term “oil” is used herein it refers to any substance that is in a viscous liquid state at ambient temperatures or slightly warmer, and is both hydrophobic (immiscible with water) and lipophilic (miscible with other oils, literally). An oil may be comprised of many different component oils. That is, an oil may contain different length molecules having various configurations. For example, an oil as used herein may contain polyunsaturated and unsaturated fatty acids. For purposes of the invention at least a portion of the oil must contain a cis-configured polyunsaturated fatty acid, meaning that the fatty acid contains more than one cis-configured double bond. A cis configuration means that adjacent hydrogen atoms are on the same side of the double bond. The rigidity of the double bond freezes its conformation and, in the case of the cis isomer, causes the chain to bend and restricts the conformational freedom of the fatty acid. The more double bonds the chain has in the cis configuration, the less flexibility it has. When a chain has many cis bonds, it becomes quite curved in its most accessible conformations. For example, oleic acid, with one double bond, has a “kink” in it, whereas linoleic acid, with two double bonds, has a more pronounced bend. Alpha-linolenic acid, with three double bonds, favors a hooked shape.

A “portion” or “component” of an oil as used herein refers to any amount greater than zero, including up to about 100 weight percent of the total oil composition.

The term “about,” as used herein, modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities. All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used herein, weight percent (wt-%), percent by weight, % by weight, and the like are synonyms that refer to the concentration of a substance as the weight of that substance divided by the total weight of the composition and multiplied by 100.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

The recitation of numerical ranges by endpoints includes all numbers subsumed within that range (e.g. 1 to 5 includes 1, 1.5, 2, 2.75, 3, 3.80, 4, and 5).

The present invention contemplates the possibility of omitting any components listed herein. The present invention further contemplates the omission of any components even though they are not expressly named as included or excluded from the invention.

The term “substantially free” may refer to any component that the composition of the invention lacks or mostly lacks. When referring to “substantially free” it is intended that the component is not intentionally added to compositions of the invention. Use of the term “substantially free” of a component allows for trace amounts of that component to be included in compositions of the invention because they are present in another component. However, it is recognized that only trace or de minimus amounts of a component will be allowed when the composition is said to be “substantially free” of that component.

By use of the term “spontaneous” combustion it is meant that an article ignites without the assistance of an open flame or without assistance of an additional heat source raising the temperature of the article.

Once an article has been contacted with oil, it is important to handle it appropriately in order to avoid any possibility of the article spontaneously combusting. One appropriate method of handling such an article is to treat it with a solution in order to minimize the cis-configured double bonds present in the polyunsaturated fatty acids of the oil. “Treating” an article according to the invention involves contacting the article with a solution containing lipoxidase enzyme for a sufficient amount of time to alter either all of or all except one remaining cis-configured double bond in the fatty acid. Lipoxidase enzyme is derived from numerous sources and is synonymous with lipoxygenase. Lipoxidase derived from soybean has the Enzyme Commission (EC) Number 1.13.11.12. That particular enzyme catalyzes the hyperoxidation of lipids containing a cis, cis-1,4-pentadiene structure and is useful in the present invention. The two terms, “lipoxidase” and “lipoxygenase” may be used interchangeably herein.

When treating an article it is important that preferably all cis-configured double bonds are removed or all but one of the cis-configured double bonds are altered. In either situation, the stress is removed from the fatty acid molecule thereby removing the instability of the molecule and the reactivity of the fatty acid molecule. Removing all except one of the cis-configured double bonds in a fatty acid greatly reduces the reactivity of the molecule. For example, linoleic acid having two cis-configured double bonds is ten times as reactive as oleic acid having one cis-configured double bond. Compare this to linolenic acid having three cis-configured double bonds which is twenty-five times as reactive as oleic acid. Oleic acid, having a single cis-configured double bond is minimally or slowly reactive.

A solution comprising lipoxidase enzyme may simply contain lipoxidase enzyme. However, as one may appreciate, such a solution of straight enzyme would be prohibitively expensive when practiced on a large scale. In methods of the invention, a solution is prepared including from about 0.001 weight percent up to about 20 weight percent lipoxidase enzyme, from about 0.01 to about 10 weight percent, from about 0.01 to about 8 weight percent, from about 0.01 to about 5 weight percent, from about 0.01 to about 3 weight percent, from about 0.01 to about 2 weight percent, from about 0.01 to about 1 weight percent, from about 0.01 to about 0.8 weight percent, from about 0.01 to about 0.5 weight percent, and from about 0.01 to about 0.2 weight percent. It is appreciated that when practicing the method of the invention, the amount of enzyme necessary in the solution will depend upon the amount of oil present on a given article to be treated and will also depend upon the number of double bonds present in the fatty acids of the oil.

As already discussed, the method of the invention is useful in treating oils having at least one cis-configured double bond or preferably more than one cis-configured double bond in the fatty acid. Examples of such oils include linolenic acid and linoleic acid. Linoleic acid is present in safflower oil, grape seed oil, poppy seed oil, sunflower oil, hemp oil, corn oil, wheat germ oil, cottonseed oil, soybean oil, walnut oil, peanut oil, sesame oil, rice bran oil, pistachio oil, canola oil, egg yolk, lard, olive oil, palm oil, cocoa butter, macadamia oil, butter, and coconut oil. Linolenic acid is present in canola oil, soybean oil, walnut oil, linseed oil, perilla oil, chia oil, and hemp oil. Oleic acid is present in olive oil, grapeseed oil, and buckthorn oil. The list of examples of oils containing fatty acids with cis-configured double bonds is not intended to be exhaustive.

When preparing solutions used in the method of the invention one may incorporate active enzymes or enzymes otherwise stabilized (such as is the case with bacterial spores capable of producing active enzymes). Since such solutions include enzymes or their stabilized counterpart, the pH and/or the water content of the solution become important. Since enzymes are proteins comprised of amino acids that depend upon their three-dimensional structure for their enzymatic activity, it is important that the enzymes remain intact. That is, the pH of a composition of the invention including an enzymatic ingredient should be such that the enzymatic component remains stable and is not denatured.

Most enzymes do not tolerate copious amounts of water or fluctuations in pH. Water and pH different from their normal pH causes denaturization of the enzyme. Once an enzyme is denatured, it is inactive. Thus, when incorporating enzymes into solution, a difficulty arises in stabilizing the enzyme. Solutions prepared in accordance with the invention method preferably include small amounts of water to no water. Likewise, such solutions incorporating lipoxidase enzyme may have a pH at or about neutral pH or between about 5 and 9, between about 6 and 8, and between about 6.5 and 7.5.

Solutions prepared to practice the invention method may be prepared by the manufacturer and provided as a ready-to-use (“RTU”) solution, or may be prepared onsite by the end user. If an RTU solution is prepared by the manufacturer, maintaining enzyme stability is much more difficult than if the solution is prepared at the customer site. For purposes of transportation, storage, and commercialization, it is preferred if a composition would have enzymatic stability for up to about one year. Up to about six months might be suitable for some purposes. If a customer prepares the solution, it is envisioned that a vile of enzyme would be provided to the customer with direction to add the vile of enzyme to the prepared solution at the time of use. If this is the case, enzymatic shelf life activity issues are greatly diminished.

An oil-stained article is treated according to the method of the invention for a time sufficient to alter all or all but one of the cis-configured double bonds present in the fatty acids. Such a time may comprise up to about 1 day, up to about 12 hours, up to about 8 hours, up to about 6 hours, up to about 4 hours, up to about 2 hours, up to about 1 hour, up to about one half an hour, up to about 20 minutes, up to about 15 minutes, up to about 10 minutes, up to about 5 minutes, and up to about 3 minutes. The treatment time may be reduced if the amount of lipoxidase enzyme is increased. Since lipoxidase is an enzyme, it does not require an additional catalyst in order to drive the reaction. Likewise, since it is an enzyme it occurs at a rate much quicker than most catalyzed reactions. Finally, since it is an enzyme it is not used up by the reaction, but remains active in the solution. Therefore, if a de minimus amount of enzyme is included in a solution used to practice the invention, it is expected the treating time will increase whereas if a larger amount of enzyme is incorporated into the solution, the treating time will be reduced. Likewise, if an unstable fatty acid is being acted upon by the enzyme, less time will be required for the enzyme to alter the cis-double bonds. For instance, it is estimated that a treating solution will effectively alter the cis-configured double bonds in linolenic acid in up to about 30 minutes, up to about 25 minutes, or up to about 20 minutes. Compare this to the same time required to alter the cis-configured double bonds in linoleic acid with all other variables remaining constant. For linoleic acid it is estimated that a treating solution will effectively alter the cis-configured double bonds in linoleic acid in up to about 7 hours, up to about 6 hours, up to about 5 hours or up to about 4 hours. The difference in reaction is attributed to the relative instability of linolenic acid as compared to that of linoleic acid. A skilled artisan will readily appreciate and recognize these concepts.

Solutions used to practice the invention may be provided as a presoak before laundering, may be provided as a laundering detergent, or may be provided as a soaking solution without any need for laundering. The latter would be the situation for treating articles such as paintbrushes, work rags or the like for which cleaning is not necessary. The method of the invention may simply be practiced before disposing of an oil-stained article. Such might be the case for disposable rags or paintbrushes. Without treating an oil-stained article such as a rag, simply disposing of it in a waste container may result in spontaneous combustion of the rag, igniting the rag and the surrounding garbage. However, if the method of the invention is practiced, the risk of fire is minimized when discarding such an article. Such a rag could be disposed of after treatment with the lipoxidase-containing solution.

In determining when to use the method of the invention it is necessary to understand if and when laundering of the article will occur. If laundering will occur off-site as in the case of a commercial launderer, then the article should be treated immediately or shortly after contacting the oil by placing the article in a treating solution. This could be accomplished by immersing the article in a bucket of treating solution or by spraying the article with the treating solution. If treated in this manner, the article never has an opportunity to spontaneously combust because the article is not exposed to oxygen for a prolonged period of time. If laundering occurs on-site, the article may still be treated immediately following oil-contact, however, the laundering process may incorporate the treating solution. That is, the treating solution may be a presoak for the laundry or the detergent may comprise the treating solution. Alternatively, the treating solution could be incorporated into a final rinse of the laundry cycle.

Suitable solutions to which it might be practical to incorporate lipoxidase enzyme are disclosed in United States patent numbers U.S. Pat. No. 6,425,959, U.S. Pat. No. 6,506,261, U.S. Pat. No. 6,624,132 and United States publications 2003/087787 and 2006/0293212 which are herein incorporated by reference in their entirety for all purposes.

An exemplary composition used to practice the method of the invention is provided in the table below.

| | | Weight | |
|---|---|---|---|
| Component | Weight percent | percent | Weight percent |
| Water | 0-70 | 0-50 | 0-25 |
| Nonionic Surfactant | 0-90 | 5-95 | 10-80 |
| Solvent | 0-50 | 2-40 | 5-30 |
| Amphoteric Solvent | 0-25 | 0.1-20 | 0.5-15 |
| Lipoxidase | 0.001-100 | 0.001-10 | 0.005-5 |

The skilled artisan will appreciate that any one or more of the components in the solution or composition other than the lipoxidase may be absent. As previously referenced, in a preferred composition the water content approaches zero while the pH remains at about neutral.

### Surfactant

For the purpose of this patent application, the term “nonionic surfactant” typically indicates a surfactant having a hydrophobic group and at least one hydrophilic group comprising a (EO)ₓ group, a (PO)_{y} group, or a (BO)_{z} group wherein x, y and z are numbers that can range from about 1 to about 100. The combination of a generic hydrophobic group and such a hydrophilic group provides substantial surfactancy to such a composition. Examples of suitable types of nonionic surfactant include the polyethylene oxide condensates of alkyl phenols. These compounds include the condensation products of alkyl phenols having an alkyl group containing from about 6 to 12 carbon atoms in either a straight chain or branched chain configuration, with ethylene oxide. Ethylene oxide being present in amounts equal to 5 to 20 moles of ethylene oxide per mole of alkyl phenol. Examples of compounds of this type include nonyl phenol condensed with an average of about 9.5 moles of ethylene oxide per mole of nonyl phenol, dodecyl phenol condensed with about 12 moles of ethylene oxide per mole of phenol, dinonyl phenol condensed with about 15 moles of ethylene oxide per mole of phenol, diisoctylphenol condensed with about 15 moles of ethylene oxide per mole of phenol.

The condensation products of aliphatic alcohols with ethylene oxide can also exhibit useful surfactant properties. The alkyl chain of the aliphatic alcohol may either be straight or branched and generally contains from about 3 to about 22 carbon atoms. Preferably, there are from about 3 to about 18 moles of ethylene oxide per mole of alcohol. The polyether can be conventionally end capped with acyl groups including methyl, benzyl, and etc. groups. Examples of such ethoxylated alcohols include the condensation product of about 6 moles of ethylene oxide with 1 mole of tridecanol, myristyl alcohol condensed with about 10 moles of ethylene oxide per mole of myristyl alcohol, the condensation product of ethylene oxide with coconut fatty alcohol wherein the coconut alcohol is a mixture of fatty alcohols with alkyl chains varying from 10 to 14 carbon atoms and wherein the condensate contains about 6 moles of ethylene oxide per mole of alcohol, and the condensation product of about 9 moles of ethylene oxide with the above-described coconut alcohol. Examples of commercially available nonionic surfactants of this type include Tergitol 15-S-9 marketed by DOW and Tomadol 91-6 marketed by Air Products.

The condensation products of ethylene oxide with a hydrophobic base formed by the condensation of propylene oxide with propylene glycol can be used. The hydrophobic portion of these compounds has a molecular weight of from about 1,500 to 1,800 and of course exhibits water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product. Examples of compounds of this type include certain of the commercially available Pluronic surfactants marketed by BASF.

Nonionic surfactants may include alcohol alkoxylates having EO, PO and BO blocks. Straight chain primary aliphatic alcohol alkoxylates can be particularly useful as non-ionic surfactants. Such alkoxylates are also available from several sources including BASF where they are known as “Plurafac” and “Pluronic” surfactants. A particular group of alcohol alkoxylates found to be useful are those having the general formula R-(EO)ₘ—(PO)ₙ wherein m is an integer from about 2 to 10 and n is an integer from about 2 to 20. R can be any suitable radical such as a straight chain alkyl group having from about 6 to 20 carbon atoms. An example of a suitable nonionic surfactant is available under the tradename Plurafac LF901 from BASF located in Germany. Such nonionic surfactants, preferably alcohol alkoxylates, are present in the invention in liquid delivery suitable for coating on a substrate an amount of up to about 40 percent by weight.

Other useful nonionic surfactants include capped aliphatic alcohol alkoxylates. These end caps include but are not limited to methyl, ethyl, propyl, butyl, benzyl and chlorine. Useful alcohol alkoxylates include ethylene diamine ethylene oxides, ethylene diamine propylene oxides, mixtures thereof, and ethylene diamine EO-PO compounds, including those sold under the tradename Tetronic. Preferably, such surfactants have a molecular weight of about 400 to 10,000. Capping improves the compatibility between the nonionic and the oxidizers hydrogen peroxide and peroxycarboxylic acid, when formulated into a single composition. Other useful nonionic surfactants are alkylpolyglycosides. The alcohol alkoxylates can be linear, branched or a combination of linear and branched. The alcohol alkoxylates can also be secondary alcohol alkoxylates. Mixtures of the above surfactants are also useful in the present invention.

Although alcohol alkoxylates are preferred, one skilled in the art will recognize that other nonionic surfactants may be incorporated into the compositions of the present invention instead of the alcohol alkoxylates. Alcohol alkoxylates are present in liquid concentrates other than those suitable for substrate coating in an amount from about 0.01 up to about 20% by weight, from about 0.05 up to about 10%, and from about 0.1 up to about 5% by weight.

Other useful nonionic surfactants can comprise a silicone surfactant including a modified dialkyl, preferably a dimethyl polysiloxane. The polysiloxane hydrophobic group is modified with one or more pendent hydrophilic polyalkylene oxide group or groups. Such surfactants provide low surface tension, high wetting, antifoaming and excellent stain removal. U.S. Pat. No. 7,199,095 incorporated herein for all purposes in its entirety teaches use of such silicone nonionic surfactants in a detergent composition. Such silicone surfactants comprise a polydialkyl siloxane, preferably a polydimethyl siloxane to which polyether, typically polyethylene oxide, groups have been grafted through a hydrosilation reaction. The process results in an alkyl pendent (AP type) copolymer, in which the polyalkylene oxide groups are attached along the siloxane backbone through a series of hydrolytically stable Si—C bond.

A second class of nonionic silicone surfactants is an alkoxy-end-blocked (AEB type) that are less preferred because the Si—O— bond offers limited resistance to hydrolysis under neutral or slightly alkaline conditions, but breaks down quickly in acidic environments.

Examples of silicone surfactants are sold under the SILWET® trademark from Momentive Performance Materials or under the TEGOPREN® trademark from Evonik Industries.

For the purposes of this invention, the term, “amphoteric surfactant” refers to a surfactant that can act either as an acid or a base. That is, an amphoteric surfactant may either accept or donate a proton. Examples of suitable amphoteric surfactants for purposes of the invention include but are not limited to alkyl betaines, alkyl aminopropyl betaines, amino propionate, sultaines, and those available under the tradenames EMPIGEN® available from Huntsman International LLC and MIRANOL® available from Rhodia to name a few.

### Solvent

A solvent is useful in the composition of the invention to serve as a thinning agent. Without an added solvent compositions of the invention tend to become gel-like or thickened and difficult to pour or distribute. With the addition of an optional solvent, the compositions flow easily and are easily dispensed as liquids. The compositions of the invention can contain a non-aqueous or aqueous solvent. Preferred solvents are non-aqueous oxygenated solvents. Oxygenated solvents include lower alkanols, lower alkyl ethers, glycols, aryl glycol ethers and lower alkyl glycol ethers. These materials are colorless liquids with mild pleasant odors, are excellent solvents and coupling agents and may be miscible with aqueous use compositions of the invention. Examples of useful solvents include methanol, ethanol, propanol, isopropanol and butanol, isobutanol, ethylene glycol, diethylene glycol, triethylene glycol, propylene glycol, dipropylene glycol, mixed ethylene-propylene glycol ethers, ethylene glycol phenyl ether, and propylene glycol phenyl ether. Substantially water soluble glycol ether solvents include propylene glycol methyl ether, propylene glycol propyl ether, dipropylene glycol methyl ether, tripropylene glycol methyl ether, ethylene glycol butyl ether, diethylene glycol methyl ether, diethylene glycol butyl ether, ethylene glycol dimethyl ether, ethylene glycol propyl ether, diethylene glycol ethyl ether, triethylene glycol methyl ether, triethylene glycol ethyl ether, triethylene glycol butyl ether, and others.

“Substantially water soluble” solvents are defined as being infinitely or 100% soluble by weight in water at 25 degrees C. “Substantially water insoluble” glycol ether solvents include propylene glycol butyl ether, dipropylene glycol butyl ether, dipropylene glycol propyl ether, tripropylene glycol butyl ether, dipropylene glycol dimethyl ether, propylene glycol phenyl ether, ethylene glycol hexyl ether, diethylene glycol hexyl ether, ethylene glycol phenyl ether, diethylene glycol phenyl ether, and others. “Substantially water insoluble” solvents are defined as 53% by weight or less of solvent is soluble in water at 25 degrees C. Preferred solvents are substantially water-soluble solvents. For reasons of low cost, commercial availability, high flash point, and solvent strength, diethylene glycol monobutyl ether is a preferred solvent.

Other solvents useful herein include the water soluble CARBITOL solvents or water-soluble CELLOSOLVE solvents. Water-soluble CARBITOL solvents are compounds of the 2-(2-alkoxyethoxy) ethanol class wherein the alkoxy group is derived from ethyl, propyl or butyl; a preferred water-soluble carbitol is 2-(2-butoxyethoxy) ethanol also known as butyl carbitol. Other suitable solvents are benzyl alcohol, and diols such as 2-ethyl-1,3-hexanediol and 2,2,4-trimethl-1,3-pentanediol. The low molecular weight, water-soluble, liquid polyethylene glycols are also suitable solvents for use in treating solutions. The alkane mono and diols, especially the C₁-C₆ alkane mono and diols are suitable for use herein. C₁-C₄ monohydric alcohols (e.g.: ethanol, propanol, isopropanol, butanol and mixtures thereof) are useful along with the C₁-C₄ dihydric alcohols, including propylene glycol.

The method of the invention incorporates a treating solution that is unique because no additional enzymatic stabilizer is necessary. Without being bound by theory it is believed that the combination of the relatively low water content, the pH, and the amount of surfactant all work synergistically to provide an environment at which an enzyme such as lipoxidase can remain stable. That is, the enzyme does not denature when placed in solution for up to about one year, up to about 9 months, up to about 6 months, or up to about 3 months.

A nonexhaustive list of examples of enzyme stabilizers that are not necessary to incorporate into the treating solution include calcium ions, boric acid, propylene glycol, short chain carboxylic acid, and boronic acid.

Beyond the lipoxidase enzyme, the solution may include any number of optional ingredients. Again, the skilled artisan will recognize that while inclusion of these ingredients may not be required in the treatment solution to reduce the likelihood of articles spontaneously combusting; these components may be included for other additional reasons. Such additional reasons include but are not limited to aesthetic enhancing ingredients.

### Optional Ingredients

The solution useful in the method of the invention may contain optional components. Such optional additional ingredients include but are not limited to surfactants including nonionic, anionic, cationic and amphoteric surfactants. The term “surfactant” or “surface active agent” refers to an organic chemical that when added to a liquid changes the properties of that liquid at a surface.

Another additional optional ingredient may include a pH modifier as may be supplied by certain acids and bases. Yet other additional optional ingredients include but are not limited to viscosity modifiers, water, builders, corrosion inhibitors, threshhold agents, anti-redeposition agents, aesthetic aids, antimicrobial agents, solidification agents, and processing aids. The term “threshold agent” refers to a compound that inhibits crystallization of water hardness ions from solution, but that need not form a specific complex with the water hardness ion. Threshold agents include but are not limited to a polyacrylate, a polymethacrylate, an olefin/maleic copolymer, and the like. An “antiredeposition agent” refers to a compound that helps keep suspended in water instead of redepositing onto the object being cleaned. Antiredeposition agents are useful in the present invention to assist in reducing redepositing of the removed soil onto the surface being cleaned.

Corrosion inhibitors that may be optionally added to the composition of the invention include silicates, phosphate, magnesium and/or zinc ions. Exemplary silicates include sodium metasilicates, sesquisilicates, orthosilicates, potassium silicates, and mixtures thereof.

Aesthetic enhancing agents such as colorants and perfume are also optionally incorporated into the concentrate composition of the invention. Examples of colorants useful in the present invention include but are not limited to liquid and powdered dyes from Milliken Chemical, Keystone, Clariant, Spectracolors, Pylam, and Liquitint Violet 0947 commercially available from Milliken Chemical.

Antifoaming agents are not necessary in solutions used in practicing the method of the invention. By antifoaming agent it is meant any compound or mixture that acts to depress the foaming or sudsing produced by a solution of a detergent composition, particularly in the presence of agitation of that solution. Also unnecessary in solutions used to practice the method of the invention are bleaching agents. Chlorine bleaches and peracid bleaching agents may be incompatible with the enzymatic component of the treating solution.

Examples of perfumes or fragrances useful in concentrate compositions of the invention include but are not limited to liquid fragrances from J&E Sozio, Firmenich, and IFF (International Flavors and Fragrances).

Preservatives are optional and are generally preferred when the concentrate and use solution pH is not high enough to mitigate bacterial growth in the concentrate. Examples of preservatives useful in compositions of the invention include but are not limited to methyl paraben, glutaraldehyde, formaldehyde, 2-bromo-2-nitropropane-1,3-diol, 5-chloro-2-methyl-4-isothiazoline-3-one, and 2-methyl-4-isothiazoline-3-one. Preservatives can be included up to about 2 wt %, up to about 1 wt %, and up to about 0.5 wt %.

It should be understood that optional water can be relatively free of hardness. It is expected that the water can be deionized to remove a portion of the dissolved solids. In contrast, the optional water may be obtained from the user's site and that water may contain varying levels of hardness depending upon the locale. Although deionized is preferred if optional water is included in the solution, water that has not been deionized may also be used. That is, the optional water may include dissolved solids, and may be characterized as hard water.

Additional enzymes may be included in treating solutions of the invention. The optional additional enzymes must be compatible and stable under similar conditions as lipoxidase. It is important that the additional enzymes do not work to alter the lipoxidase enzyme. The skilled artisan will recognize that among those suitable for optional incorporation include proteases, amylases, cellulases, pectinases, or other lipases.

Chlorine bleach scavengers may be incorporated into treating solutions of the invention. Such chlorine bleach scavengers may be included to prevent chlorine bleach species present in many water supplies from attacking and inactivating the lipoxidase enzyme. Suitable chlorine scavengers are well known and may include salts containing ammonium cations or sulfite, bisulfite, thiosulfite, thiosulfate, iodide, etc. Antioxidants such as carbamate, ascorbate, etc., organic amines such as ethylenediaminetetracetic acid (EDTA) or alkali metal salt thereof, monoethanolamine (MEA), and mixtures thereof can likewise be used. Other conventional scavengers such as bisulfate, nitrate, chloride, sources of hydrogen peroxide such as sodium perborate tetrahydrate, sodium perborate monohydrate and sodium percarbonate, as well as phosphate, condensed phosphate, acetate, benzoate, citrate, formate, lactate, malate, tartrate, salicylate, etc. and mixtures thereof can be used if desired.

### EXAMPLES

### Example 1

Wash 'N Walk™ floor cleaner available from Ecolab Inc. located in St. Paul, Minn. was diluted at a dilution of 2 ounces per gallon with tap water. One hundred milliliters of the diluted Wash 'N Walk™ floor cleaner was placed in two beakers and 50 ppm linoleic acid was added. Lipoxidase enzyme was added to one beaker at a concentration of 500 ppm. After about 12 hours, a sample from each beaker was placed in a mass spectrometer and analyzed. Only the beaker lacking the lipoxidase enzyme had any remaining linoleic acid. The beaker including the lipoxidase enzyme had been converted by degrading the cis-configured double bonds.

### Example 2

Wash 'N Walk™ floor cleaner available from Ecolab Inc. located in St. Paul, Minn. was diluted at a dilution of 2 ounces per gallon with tap water. One hundred milliliters of the diluted Wash 'N Walk™ floor cleaner was placed in two beakers and 50 ppm linolenic acid was added. Lipoxidase enzyme was added to one beaker at a concentration of 500 ppm. After about 15 minutes, a sample from each beaker was placed in a mass spectrometer and analyzed. Only the beaker lacking the lipoxidase enzyme had any remaining linolenic acid. The beaker including the lipoxidase enzyme had been converted by degrading the cis-configured double bonds.

The above-described examples demonstrate that lipoxidase enzyme is effective at degrading cis-configured double bonds. Without being bound by theory it is hypothesized that the linolenic acid degradation proceeded more quickly than that of the linoleic acid to the instability of the linolenic acid as compared to the linoleic acid. Once the double bonds in each of the fatty acids are altered they become less reactive or nonreactive thus reducing their ability to spontaneously combust any articles.

The invention has been described with reference to various specific and preferred embodiments and techniques. However, it should be understood that many variations and modifications may be made while remaining within the spirit and scope of the invention.

We claim:

1. A method of reducing the occurrence of spontaneous combustion of oil-stained articles, comprising the steps of:
providing an article previously contacted with oil, the oil comprising at least one cis-configured double bond in the fatty acid,
providing a solution comprising lipoxygenase,
applying the solution to the article for sufficient time to treat the oil wherein treating comprises allowing the lipoxygenase to alter the cis-configured double bonds in the oil.

2. The method of claim 1 wherein the article was washed after contact with the oil and before treating with the lipoxygenase solution.

3. The method of claim 1 further comprising the step of laundering the article after treatment.

4. The method of claim 1 wherein the oil is comprised of linolenic acid or linoleic acid.

5. The method of claim 4 wherein the oil is comprised of linolenic acid and treating comprises degrading at least two of the cis-configured double bonds present in the linolenic acid.

6. The method of claim 1 wherein treating comprises degrading all except one of the cis-configured double bonds.

7. The method of claim 1 wherein the article is comprised of a linen.

8. The method of claim 1 wherein sufficient time comprises up to about 1 hour.

9. The method of claim 1 wherein sufficient time comprises up to about 20 minutes.

10. The method of claim 1 wherein the applying step is accomplished during laundering of an article.

11. The method of claim 1 wherein the applying step is accomplished during a presoak before laundering.

12. The method of claim 1 wherein the solution comprises less than 10 weight percent lipoxygenase.

13. The method of claim 1 wherein the solution comprises less than 1 weight percent lipoxygenase.

14. The method of claim 1 wherein the solution further comprises an enzymatic stabilizer.

15. The method of claim 14 wherein the enzymatic stabilizer is comprised of at least one of calcium ions, boric acid, propylene glycol, glycerin, glycerin ethers, short chain carboxylic acid, boronic acid, or combinations thereof.

16. The method of claim 1 wherein the solution further comprises at least one of a surfactant, antifoaming agent, corrosion inhibitor, aesthetic enhancing agent, builder, preservative, or combinations thereof.

17. A method of treating oil-stained articles, comprising the steps of:
providing an article previously contacted with oil, the oil comprising at least one cis-configured double bond in the fatty acid,
providing a solution comprising lipoxygenase,
applying the solution to the article for sufficient time to treat the oil wherein treating comprises allowing the lipoxygenase to alter the cis-configured double bonds in the oil,
and wherein the method reduces the occurrence of spontaneous combustion of oil-stained articles.

18. The method of claim 17 further comprising the step of laundering the article after treatment.

19. The method of claim 17 wherein the oil is comprised of linolenic acid or linoleic acid.

20. The method of claim 17 wherein the article is comprised of a linen.
